(19) United States
(12) Patent Application Publication
(10) Pub. No.: US 2017/0139105 A1
(43) Pub. Date: May 18, 2017

(54) INTEGRATED BACK LIGHT UNIT WITH REMOTE PHOSPHOR

(71) Applicant: GLO AB, Lund (SE)

(72) Inventors: Michael JANSEN, Palo Alto, CA (US); Neil DEEMAN, Danville, CA (US)

(21) Appl. No.: 15/353,100

(22) Filed: Nov. 16, 2016

Related U.S. Application Data
(60) Provisional application No. 62/256,275, filed on Nov. 17, 2015.

(51) Int. Cl. F21V 8/00; F21K 9/64; F21K 9/62

(52) U.S. Cl. CPC G02B 6/0026; G02B 6/0068; F21K 9/62; F21K 9/64; G02B 6/0073

(57) ABSTRACT

An integrated back light unit includes a light emitting device assembly including a plurality of light emitting devices located in a reflective mixing chamber containing reflective walls, a phosphor material which is located remotely from the LEDs and converts the light from the light emitting devices into phosphor converted light, and a light guide unit optically coupled to the light emitting device assembly to receive light from the light emitting devices and the phosphor material. The combination of the light from the plurality of light emitting devices that passes through the phosphor material and the phosphor converted light can provide white light that can be scattered by the light guide unit to provide white backlight.

### RELATED APPLICATIONS

The present application claims the benefit of priority of U.S. Provisional Application No. 62/256,275 filed on Nov. 17, 2015, the entire contents of which are incorporated herein by reference.

### FIELD

The embodiments of the invention are directed generally to semiconductor light emitting devices, such as light emitting diodes (LEDs), and specifically an integrated back light LED unit.

### BACKGROUND

LEDs are used in electronic displays, such as liquid crystal displays in laptops or LED televisions. Conventional LED units are fabricated by mounting LEDs to a substrate, encapsulating the mounted LEDs and then optically coupling the encapsulated LEDs to an optical waveguide. The conventional LED units may suffer from poor optical coupling.

### SUMMARY

According to an aspect of the present disclosure, an integrated back light unit is provided, which comprises: a light emitting device assembly comprising at least one light emitting device located in a reflective mixing chamber containing reflective walls, a light guide unit optically coupled to said at least one light emitting device to receive light from the at least one light emitting device, and a phosphor material which is located remotely from the at least one light emitting device and configured to emit phosphor converted light upon irradiation from the at least one light emitting device.

### BRIEF DESCRIPTION OF THE DRAWINGS

FIG. 1 is a plan view of an exemplary integrated back light unit according to an embodiment of the present disclosure.

FIG. 2 is a vertical cross-sectional view of a first exemplary configuration of the exemplary integrated back light unit according to an embodiment of the present disclosure.

FIG. 3 is a vertical cross-sectional view of a second exemplary configuration of the exemplary integrated back light unit according to an embodiment of the present disclosure.

FIG. 4 is a vertical cross-sectional view of a third exemplary configuration of the exemplary integrated back light unit according to an embodiment of the present disclosure.

### DETAILED DESCRIPTION

In one embodiment, color uniformity in a back light unit including a light emitting device, such as a light bar, can be improved by selectively adding a phosphor which is located remotely from the light emitting device. Throughout the drawings, like elements are described by the same reference numerals. The drawings are not drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure.

As used herein, an “integrated back light unit” refers to a unit that provides the function of illumination for liquid crystal displays (LCDs) or other devices that display an image by blocking a subset of background illumination from the side or from the back. As used herein, a “light emitting device” can be any device that is capable of emitting light in the visible range (having a wavelength in a range from 400 nm to 800 nm), in the infrared range (having a wavelength in a range from 800 nm to 1 mm), or in the ultraviolet range (having a wavelength is a range from 10 nm to 400 nm). The light emitting devices of the present disclosure include light emitting devices, such as semiconductor light emitting diodes (LEDs) emitting light in the visible range.

As used herein, a “light emitting device assembly,” or an “LED assembly” refers to an assembly in which at least one light emitting device, such as at least one light emitting diode (LED), is structurally fixed with respect to a support structure, which can include, for example, a substrate, a matrix, or any other structure configured to provide stable mechanical support to the at least one light emitting device.

As used herein, a “light bar” refers to a light emitting device assembly and supporting electrical and structural elements that structurally supports the light emitting device assembly and provides electrical wiring used for operation of the light emitting device assembly.

As used herein, a “light guide unit” refers to a unit configured to guide light emitted from at least one light emitting device in a light emitting device assembly in a direction or directions that are substantially different from the initial direction of the light as emitted from the at least one light emitting device. A light guide unit of the present disclosure may be configured to reflect or scatter light along a direction different from the initial direction of the light as emitted from the at least one light emitting device. In one embodiment, the light guide unit of the present disclosure includes a light guide plate, and may be configured to reflect light along directions about the surface normal of the bottom surface of the light guide plate, i.e., along directions substantially perpendicular to the bottom surface of the light guide plate. An integrated back light unit can include a combination of a light bar, a light guide unit, and optional components that structurally support the light bar and the light guide unit.

As used herein, the “Commission Internationale de l'Eclairage model,” or the “CIE model” is a color model based on human perception developed by the CIE (Commission Internationale de l'Eclairage) committee as established in 1931. As used herein, a “CIEx” is the x-coordinate value of a color in a CIE model, and a “CIEy” is the y-coordinate value of a color in the CIE model.

As used herein, “red light” refers to light having a wavelength in a range from 620 nm to 750 nm. A “red-light-emitting diode,” a “red-light-emitting LED,” or a “red diode” refers to a diode having a peak emission wavelength in a range from 620 nm to 750 nm.

As used herein, “green light” refers to light having a wavelength in a range from 495 nm to 570 nm. A “green-light-emitting diode,” a “green-light-emitting LED,” or a “green diode” refers to a diode having a peak emission wavelength in a range from 495 nm to 570 nm.

As used herein, “blue light” refers to light having a wavelength in a range from 400 nm to 495 nm. A “blue-light-emitting diode,” a “blue-light-emitting LED,” or a “blue diode” refers to a diode having a peak emission wavelength in a range from 400 nm to 495 nm.

As used herein, “white light” refers to light having the color that corresponds to any color within the area defined by the equation, (x−0.280)²+(y−0.270)²<0.08² in the CIE 1931 x,y chromaticity space. For example, the white light emitted from the light emitting device assembly 300 may have the CIE coordinates of x=0.28, y=0.27 for a back light unit.

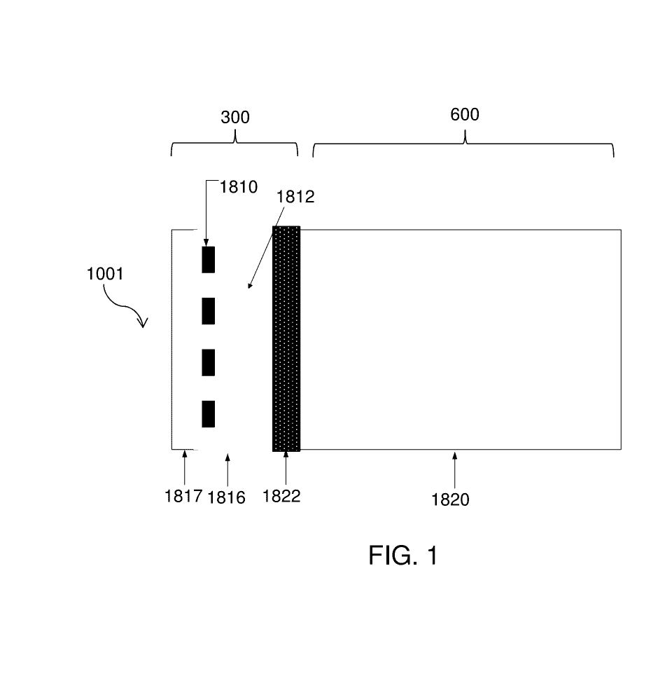

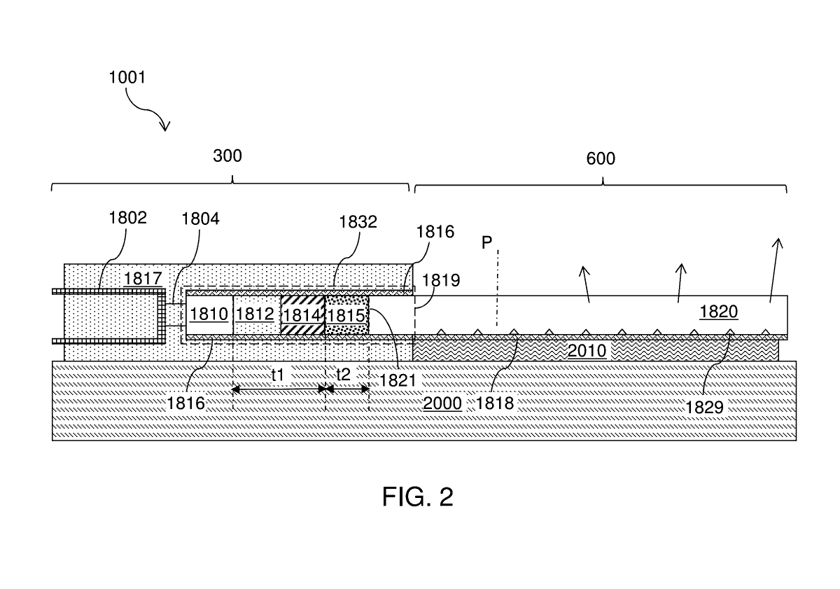

Referring to FIGS. 1 and 2, an exemplary integrated back light unit 1001 of an embodiment of the present disclosure is shown, which includes a light emitting device assembly 300, a light guide unit 600, and a substrate 2000. The light emitting device assembly 300 can be a light bar. The substrate 2000 can be an insulator substrate, a semiconductor substrate, a conductive substrate, or a combination or a stack thereof, and can be replaced with any rigid structure that can provide structural support to the light emitting device assembly. The substrate 2000 can be an optional component.

The light emitting device assembly 300 can include a support (1817, 1802, 1804) having a shape that defines an interstice 1832 therein. The interstice 1832 is a cavity having an opening 1819 toward a side. The interstice 1832 cavity can be a space in the encapsulating material that is occupied by the LEDs 1810. If the light emitting device assembly 300 contains a reflector (e.g., reflective material layer 1816), then the interstice 1832 can be a cavity in the reflector with the opening 1819 toward the side facing light guide unit 600. In one embodiment, the interstice 1832 can have a uniform width in proximity to the opening 1819 at the side, and can have as many number of cavity extensions away from the opening 1819 as the number of light emitting devices 1810 (e.g., blue-light-emitting LEDs described above) to be embedded within the support (1817, 1802, 1804). Alternately, the number of cavity extensions can be the same as the number of clusters of light emitting devices 1810 if a plurality of the light emitting devices 1810 are bundled as a cluster. Yet alternately, the cavity extensions can be merged in case the light emitting devices 1810 laterally contact one another within the interstice 1832.

In one embodiment, the portion of the interstice 1832 that is proximal to the opening 1819 can contain a substantially rectangular cavity having a uniform width. In another embodiment, the portion of the interstice 1832 that is proximal to the opening 1819 can be corrugated such that the light guide unit 600 may be inserted into the interstice with precision alignment. The shape of the interstice 1832 can be adjusted to accommodate the type, the shape, and the nature of each of the at least one light emitting device 1810. In an illustrative example, the interstice 1832 may include portions having a slit shape, a cylindrical shape, a conical shape, a polyhedral shape, a pyramidal shape, or any three-dimensional curvilinear shape to accommodate embedding of the at least one light emitting device 1810, to accommodate a light path between each of the at least one light emitting device 1810 and the opening 1819 of the interstice 1832, and to accommodate insertion of a portion of the light guide unit 600 into the interstice 1832.

An optional source-side reflective material layer 1816 can be formed on at least a portion of the sidewalls of the interstice 1832. The source-side reflective material layer 1816 can be a layer of a light-reflecting material such as a silver or aluminum. In one embodiment, the source-side reflective material layer 1816 can be formed as a coating. Alternatively, the source-side reflective material layer can be formed only on the light emitting device 1810 to form the “bottom” of the interstice 1832 but not the sidewalls of the interstice 1832. In this case, the encapsulating matrix 1817 and/or the transparent encapsulant portion 1812 may form the sidewalls of the interstice 1832 containing the light emitting device 1810.

The support (1817, 1802, 1804) can include a lead structure 1802 that can be a molded lead frame, a circuit board (e.g., printed circuit board), or any structure that can house the power supply wiring to each of the at least one light emitting device 1810. Further, the support (1817, 1802, 1804) can include leads 1804 that provide electrical connection from the lead structure 1802 to the various nodes of the at least one light emitting device 1810. The support (1817, 1802, 1804) can further include an encapsulating matrix 1817, which can be molded to form the interstice 1832 therein. In one embodiment, the encapsulating matrix 1817 can be a plastic material or a polymer LED package made of an opaque material or an optically transparent material. As used herein, an “optically transparent material” refers to a material that is at least 50% transmissive at the wavelength of the light emitted from the at least one light emitting device 1810. As used herein, an “opaque material” refers to any material that is not an optically transparent material. A housing (not shown) may be provided for the encapsulating matrix 1817 as needed.

Each of the at least one light emitting device 1810 can be located in the interstice 1832 and embedded within the support (1817, 1802, 1804) such that the electrically active nodes of the at least one light emitting device 1810 contact the leads 1804. Each light emitting device 1810 can be electrically connected to the leads 1804 in any suitable technique for bonding or attachment such as flip chip bonding or wire bonding. The encapsulating matrix 1817 of the support is then formed over the light emitting device 1810.

In one embodiment, each of the at least one light emitting device 1810 may include one or more light-emitting semiconductor elements, such as blue-light-emitting light emitting devices (LEDs). In this case, the blue-light-emitting LEDs 1810 are not in direct contact with a phosphor material.

In one embodiment, the blue-light-emitting LEDs 1810 may replace the entire set of the first color light emitting LEDs (i.e., first-type light emitting devices), second color light emitting LEDs (i.e., second-type light emitting devices), and third color light emitting LEDs (i.e., third-type light emitting devices) employed in a prior art integrated back light unit including three types of LEDs emitting light at different wavelengths (such as red, green, and blue). Alternatively, the blue-light-emitting LEDs 1810 may replace only a subset of light emitting LEDs within the entire set of the first color light emitting LEDs (i.e., first-type light emitting devices), second color light emitting LEDs (i.e., second-type light emitting devices), and third color light emitting LEDs (i.e., third-type light emitting devices) employed in a prior art integrated back light unit including three types of LEDs emitting light at different wavelengths. Yet alternately, the blue-light-emitting LEDs 1810 may be employed in addition to the entire set of the first color light emitting LEDs (i.e., first-type light emitting devices), second color light emitting LEDs (i.e., second-type light emitting devices), and third color light emitting LEDs (i.e., third-type light emitting devices) employed in a prior art integrated back light unit including three types of LEDs emitting light at different wavelengths.

Any suitable LED structure may be utilized for each of the at least one blue-light-emitting light emitting device 1810. In embodiments, the LED may be a nanowire-based LED. Nanowire LEDs are typically based on one or more pn- or pin-junctions. Each nanowire may comprise a first conductivity type (e.g., doped n-type) nanowire core and an enclosing second conductivity type (e.g., doped p-type) shell for forming a pn or pin junction that in operation provides an active region for light generation. An intermediate active region between the core and shell may comprise a single intrinsic or lightly doped (e.g., doping level below 10¹⁶ cm⁻³) semiconductor layer or one or more quantum wells, such as 3-10 quantum wells comprising a plurality of semiconductor layers of different band gaps. Nanowires are typically arranged in arrays comprising hundreds, thousands, tens of thousands, or more, of nanowires side by side on the supporting substrate to form the LED structure. The nanowires may comprise a variety of semiconductor materials, such as III-V semiconductors, for example III-nitride semiconductors, and suitable materials include, without limitation InN, GaInN, GaN, AlGaN, or AlGaInN. The supporting substrate may include, without limitation, III-V or II-VI semiconductors, Si, Ge, Al₂O₃, SiC, Quartz and glass. Further details regarding nanowire LEDs and methods of fabrication are discussed, for example, in U.S. Pat. Nos. 7,396,696, 7,335,908 and 7,829,443, PCT Publication Nos. WO20100014032, WO20008048704 and WO200071802781, and in Swedish patent application SE 1050700-2, all of which are incorporated by reference in their entirety herein.

Alternatively, bulk (i.e., planar layer type) LEDs may be used instead of or in addition to the nanowire LEDs. Furthermore, while inorganic semiconductor nanowire or bulk light emitting devices are preferred, any other light emitting devices may be used instead, such as laser, organic light emitting device (OLED) (including small molecule, polymer and/or phosphorescent based OLED), light emitting electrochemical cell (LEC), chemoluminescent, fluorescent, cathodoluminescent, electron stimulated luminescent (ESL), resistive filament incandescent, halogen incandescent, and/or gas discharge light emitting device. Each blue-light-emitting light emitting device 1810 may emit any suitable radiation wavelength (e.g., peak or band), such as a peak blue wavelength in a range between 400 and 495 nm.

An optically transparent encapsulant portion 1812 can be formed on each of the at least one blue-light-emitting light emitting device 1810 within the interstice 1832. If the encapsulating matrix 1817 is optically transparent and the source-side reflective material layer 1816 is omitted or not formed on the sidewalls of the interstice 1832, then the optically transparent encapsulant portion 1812 can be a part of the encapsulating matrix 1817 located between the light emitting device 1810 and the light guide unit 600. In this case, the optically transparent encapsulant portion 1812 can be a part of the encapsulating matrix 1817 comprise the same optically transparent material (e.g., epoxy, silicone, or polymer) and are formed in the same encapsulation step over the light emitting device 1810.

In one embodiment, each optically transparent encapsulant portion 1812 can include a transparent dielectric material such as heat cured silicone. Silicone is a polymer derived from polymerizing repeating units of siloxane, which is a functional group of two silicon atoms and one oxygen atom and optionally combined with carbon and/or hydrogen. Heat cured silicone is silicone that can be cured by applying heat, which can be typically in a range from 90 degrees Celsius to 150 degrees Celsius. Heat cured silicone can be applied in an uncured form after the at least one blue-light-emitting light emitting device 1810 is disposed in the interstices 1832, and can be subsequently cured by applying heat to provide the optically transparent encapsulant portions 1812 that include heat cured silicone in a cured form. The optically transparent encapsulant portions 1812 adhere to a respective blue-light-emitting light emitting device 1810 and to the encapsulating matrix 1817. The optically transparent encapsulant portions 1812 can encapsulate, and can attach bars of blue light-emitting diodes (LED) on to light guide plates (LGP) in various edge-lit displays.

At least one optical launch 1814 can be formed on a subset of the optically transparent encapsulant portions 1812. In one embodiment, an optical launch 1814 can be formed on each optically transparent encapsulant portion 1812. In another embodiment, optical launches 1814 can be formed on a subset of the optically transparent encapsulant portion 1812, and not formed on a complementary subset of the optically transparent encapsulant portions 1812. Each optical launch 1814 may include silicone, polymer, and/or epoxy.

The lateral thickness t1 of the combination of the optically transparent encapsulation portions 1812 and the optical launches 1814 (which is herein referred to a first lateral thickness), as measured along the primary direction of light propagation (which is a horizontal direction), may be in a range from 100 microns to 1,600 microns, and/or may be in a range from 200 microns to 800 microns, and/or may be in a range from 400 microns to 600 microns, although lesser and greater first lateral thicknesses can also be employed.

Each of the encapsulating matrix 1817 and the optically transparent encapsulant portion(s) 1812 and the optical launches 1814 can be at least 80% transmissive at the wavelength(s) of the light emitted from the at least one blue-light-emitting light emitting device 1810. In one embodiment, each of the encapsulating matrix 1817, the optically transparent encapsulant portion(s) 1812 and the optical launches 1814 can be 80%-99% transmissive at the wavelength(s) of the light emitted from the at least one blue-light-emitting light emitting device 1810. In one embodiment, each of the encapsulating matrix 1817, the optically transparent encapsulant portion(s) 1812 and the optical launches 1814 can be 80%-99% transmissive over the visible wavelength range. In an illustrative example, the materials for the encapsulating matrix 1817, the optically transparent encapsulant portion(s) 1812 and the optical launches 1814 may be independently selected from silicone, acrylic polymer (e.g., poly(methyl methacrylate) (“PMMA”), and epoxy. In one embodiment, the encapsulating matrix 1817, the optically transparent encapsulant portion(s) 1812 and the optical launches 1814 can comprise the same material that is formed at the same time over the light emitting devices 1810. In one embodiment, a light bar may be used as the light emitting device assembly 300 of the present disclosure.

The light guide unit 600 includes a light guiding plate 1820 having a plurality of extraction features 1829 configured to reflect or scatter light from the at least one blue-light-emitting light emitting device 1810. The plurality of light extraction features 1829 reflect or scatter light to the front side of the light guide unit 600. The general directions along which the light from the at least one blue-light-emitting light emitting device 1810 is reflected or scattered is illustrated by the three upward-pointing arrows in FIG. 2.

In one embodiment, the light guide unit 600 can include a light guide plate 1820, which can be an optically transparent plate having a substantially uniform thickness. In one embodiment, the plurality of extraction features 1829 may be located on a surface or, or within, the light guide plate 1820. In one embodiment, the plurality of extraction features 1829 can be geometrical features on the bottom surface of the light guide plate 1820. The geometrical features can include, for example, protrusions and/or recesses on the bottom surface of the light guide plate 1820. In one embodiment, each of the geometrical features can have, for example, a prism shape, a pyramidal shape, a columnar shape, a conical shape, or a combination thereof. The geometrical features may be discrete features not adjoined to one another, or may be adjoined to one another to form a contiguous structure. In one embodiment, a dimension of each geometrical feature along the direction of the initial direction of the light rays can be in a range from ¼ of the wavelength of the light emitted from the at least one blue-light-emitting light emitting device 1810 to about 1000 times the wavelength of the light emitted from the at least one blue-light-emitting light emitting device 1810, although lesser and grater dimensions can also be employed.

The plurality of extraction features 1829 can be printed geometrical features on a surface of the light guide plate 1820 to affect the extraction and transmission of photons traveling within the light guide plate 1820. The printed feature can be optimized to absorb, reflect, or partially reflect and absorb the photons from the at least one blue-light-emitting light emitting device 1810. The at least one of the printed geometrical features may have a shape selected from a rectilinear shape, a curvilinear shape, a polygonal shape, and a curved shape, and may be optimized to obtain a desired optical emission pattern from the surface of the light guide plate 1820. Inkjetting, stenciling or other suitable pattern transferring process can form the desired geometrical features of the extraction features 1829. A suitable polymer-based or solvent-based carrier can deliver the desired material for the plurality of extraction features 1829 to the surface of the light guide plate 1820. The delivered material of the plurality of extraction features 1829 can be absorptive, reflective, or partially transmissive.

The light guide unit 600 can further include a backside light reflection layer 1818, which is a light reflection layer positioned on the bottom side of the light guide plate 1820. The backside light reflection layer 1818 functions as a back plate that underlies the light guide plate 1820, and reflects light from the at least one light emitting device 1000 to the front side of the light guide unit 600. The backside light reflection layer 1818 can be a layer of a light-reflecting material such as silver or aluminum, or a coating of a light-reflecting material on a flexible or non-flexible layer. In one embodiment, the backside light reflection layer 1818 can include a thermally conductive material such as metal. In one embodiment, a thermally conductive layer 2010 can be provided between the backside light reflection layer 1818 and the substrate 2000 to facilitate heat transfer from the backside light reflection layer 1818 to the substrate 2000 so that overheating of the backside light reflection layer 1818 is avoided.

The light guide unit 600 is optically coupled to the at least one blue-light-emitting light emitting device 1810. The light guide unit 600 can be inserted into the interstice 1832, or its edge can be positioned next to the opening 1819 of the respective interstice 1832 or adjacent to the optically transparent encapsulant portion 1812 and/or the optical launch 1814 of the light emitting device 1810. In one embodiment, the thickness of the light guide unit 600 and the width of the interstice 1832 can be substantially the same. Alternatively, the width of the interstice 1832 can be less than the thickness of the light guide unit 600 be an offset in a range from 0.001 micron to 5 micron for a tight fit upon insertion, although lesser and greater offsets can also be employed. In one embodiment the thickness of the light guide unit 600 may be in a range from 0.2 mm to 0.8 mm, and/or may be in a range from 0.3 mm to 0.6 mm, and/or may be in a range from 0.4 mm to 0.5 mm, although lesser and greater thicknesses can also be employed. While a configuration in which the light guide unit 600 is inserted into the interstice 1832 is illustrated in FIG. 2, in an alternative embodiment the light guide unit 600 is placed adjacent to the interstice 1832 in any manner provided that the optical coupling is provided between the at least one blue-light-emitting light emitting device 1810 and the light guide unit 600, such as shown in FIGS. 1 and 2, for example. Generally, at least a distal portion of the light guide unit 600 extends outside the interstice 1832.

In one embodiment, a first portion of the light guide unit 600 can be flexibly positioned within the interstice 1832, and a second portion of the light guide unit 600 extends outside the interstice 1832. In one embodiment, the second portion of the light guide unit 600 can protrude out of the interstice 1832. The first portion of the light guide unit 600 is herein referred to as a proximal portion of the light guide unit 600, and the second portion of the light guide unit 600 is herein referred to as a distal portion of the light guide unit 600.

Prior to inserting the light guide unit 600 into the interstice 1832, an adhesive material (e.g., adhesive epoxy or two sided adhesive tape) can be applied to a proximal sidewall of the light guide unit 600 that is the most proximate to the blue-light-emitting light emitting devices 1810 and/or to a physically exposed distal sidewall of each optical launch 1814. If an optical launch 1814 is not employed for one or more of the blue-light-emitting light emitting devices 1810, then the adhesive material can be applied to each physically exposed distal sidewall of the optically transparent encapsulant portions 1812. Upon assembly of the light guide unit 600 and the light emitting device assembly 300 with the adhesive material therebetween, the adhesive material can be cured (e.g., if made of epoxy) or pressed to adjacent parts (e.g., if made of two sided adhesive tape) to form an adhesive material portion 1815, which is bonded to distal sidewalls of the optical launches 1814 and, if the optical launch is not employed for one or more of the blue-light-emitting light emitting devices 1810, to the distal sidewalls of the optically transparent encapsulant portions 1812. The adhesive material portion 1815 is bonded to the proximal sidewall surface 1821 of the light guide plate 600 and the distal sidewalls of the optical launches 1814 and optionally to the distal sidewalls of the optically transparent encapsulant portions 1812 (if an optical launch is not provided for the corresponding blue-light-emitting light emitting device 1810).

The lateral thickness t2 of the adhesive material portion 1815 (which is herein referred to a second lateral thickness), as measured along the primary direction of light propagation, may be in a range from 25 microns to 400 microns, and/or may be in a range from 50 microns to 200 microns, and/or may be in a range from 100 microns to 150 microns, although lesser and greater first lateral thicknesses can also be employed.

In one embodiment, the adhesive material portion 1815 includes ultraviolet radiation cured silicone, i.e., silicone that can be, or has been, cured by ultraviolet radiation. Thus, an ultraviolet radiation cured silicon in uncured form can be applied as the adhesive material prior to assembly of the light guide plate 600 and the light emitting device assembly 300, and ultraviolet radiation can be applied to the adhesive material to form the adhesive material portion 1815 that includes ultraviolet cured silicon in cured form.

In an alternative embodiment, the adhesive material portion 1815 includes epoxy. In this case, epoxy in uncured form can be applied as the adhesive material prior to assembly of the light guide plate 600 and the light emitting device assembly 300, and can be subsequently cured to form the adhesive material portion 1815 that includes epoxy in cured form. In an alternative embodiment, the adhesive material portion 1815 comprises a two sided adhesive tape which is adhered to adjacent components by pressing.

In one embodiment, a phosphor material can be embedded into the adhesive material portion 1815. The phosphor material may be a yellow emitting phosphor material, a green emitting phosphor material or a combination of green and red emitting phosphor materials which combine with the blue light emitted by the blue-light-emitting LEDs 1810 to together appear to emit white light to an observer. Any suitable phosphor materials, such as YAG:Ce, LSN (e.g., La₃Si₆N₁₁:Ce), CASN/SCASN ((Sr,Ca)AlSiN₃:Eu) or AlSiON:Eu type phosphor materials may be used.

Thus, in this embodiment, blue-light-emitting LEDs 1810 with phosphor material converted emission are used as the light source of white light for the back light unit 1001 emission. Further, the phosphor material is a remote phosphor material, i.e. there is a physical space between the blue-light-emitting LEDs 1810 and the adhesive material portion 1815. The physical space is filled with an optically transparent encapsulant portion 1812, which can include silicone or another similar encapsulating material. The back light unit 1001 also optionally includes a highly reflective mixing chamber that is at least partially filled with the optically transparent encapsulant portion 1812 and containing reflective walls 1816. The mixing chamber traps the photons, so that they take at least one bounce from the reflective walls 1816 in the mixing chamber before exiting the mixing chamber into the light guiding plate through the remote phosphor material 1822. In one embodiment, the phosphor material can absorb blue photons (i.e., photons having the same wavelength as emitted by the blue-light-emitting LEDs 1810) and can emit upconverted photons in all directions. The upconverted photons emitted backwards can be trapped in the mixing chamber, and can be extracted (e.g., reflected) forward if the mixing chamber has high reflectivity. Thus, in one embodiment, the phosphor material is configured to emit upconverted photons in all directions such that the upconverted photons emitted backwards into the reflective mixing chamber are then extracted forward back toward the phosphor material from the mixing chamber by being reflected from the reflective sidewalls of the mixing chamber.

In the above embodiment, the remote phosphor material 1822 is embedded in the adhesive material portion 1815, which can include silicone or epoxy. In the above embodiment, silicone can be employed as the matrix material of the adhesive material portion 1815, which functions as an adhesive and an encapsulant material for phosphor particles. In another embodiment, the remote phosphor material 1822 is embedded in a remote part of the optical launch 1814 which is distal from the light emitting device 1810.

In another embodiment shown in FIG. 1, the optical launch 1814 may be omitted, and the remote phosphor material 1822 is embedded in a distal part of the optically transparent encapsulant portion 1812 that is located closer to the light guide unit 600 than to the at least one LED 1810. A proximal part of the optically transparent encapsulant portion 1812 is located between the remote phosphor material 1822 and the at least one LED 1810. The proximal part of the optically transparent encapsulant portion 1812 does not contain any phosphor material.

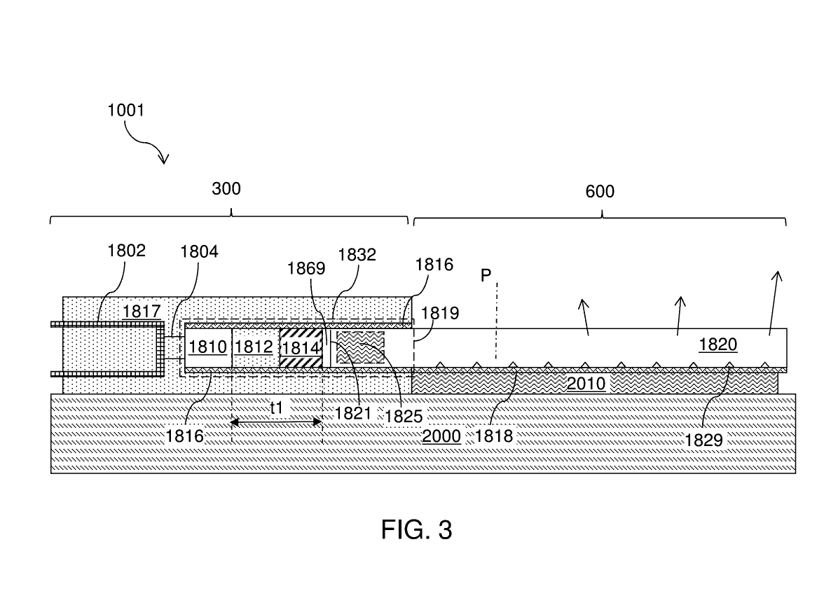

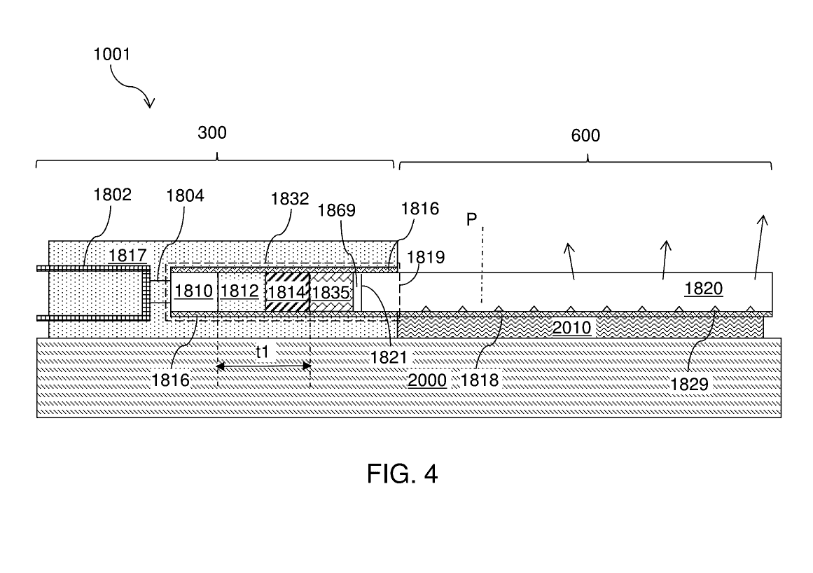

In another embodiment, the adhesive material portion 1815 may be omitted. In this embodiment, the phosphor material is embedded in the end portion 1825 of the light guide plate 1820 facing the LEDs as illustrated in FIG. 3, or in a separate polycarbonate layer 1835 between the light bar and the light guide plate 1820 as illustrated in FIG. 4. In these embodiments, there may be an air gap 1869 between the light bar 300 and the light guiding unit 600.

The remote phosphor approach provides higher system efficiency, higher uniformity and lower cost. Higher efficiency is realized because of reduced conversion losses in the phosphor material. Even with fewer LEDs, the mixing chamber has a homogenizing function, resulting in a uniform light distribution at the phosphor/LGP 1820 boundary. Because of the higher efficiency and inherent uniformity achieved through the use of the mixing chamber, fewer LEDs may be used at a lower cost) to achieve uniform white light emission. Because the phosphor material is remotely positioned from LEDs, a wider spread of dominant wavelength blue LEDS (more bins) may be used while still achieving color uniformity within each device.

The phosphor converted light emitted from the phosphor material upon irradiation by blue light from the blue-light-emitting LEDs 1810 can be employed in lieu of the light provided by the entire set of the first color light emitting LEDs (i.e., first-type light emitting devices), second color light emitting LEDs (i.e., second-type light emitting devices), and third color light emitting LEDs (i.e., third-type light emitting devices) employed in a prior art integrated back light unit employing three types of LEDs emitting light at different wavelengths to provide white light to a light guide unit of the integrated back light unit of the present disclosure.

Alternatively, the phosphor converted light emitted from the phosphor material upon irradiation by blue light from the blue-light-emitting LEDs 1810 can be employed in combination with a subset of the entire set of the first color light emitting LEDs (i.e., first-type light emitting devices), second color light emitting LEDs (i.e., second-type light emitting devices), and third color light emitting LEDs (i.e., third-type light emitting devices) employed in a prior art integrated back light unit employing three types of LEDs emitting light at different wavelengths to provide white light to a light guide unit of the integrated back light unit of the present disclosure.

Yet alternatively, the phosphor converted light emitted from the phosphor material upon irradiation by blue light from the blue-light-emitting LEDs 1810 can be employed in combination with a subset of the entire set of the first color light emitting LEDs (i.e., first-type light emitting devices), second color light emitting LEDs (i.e., second-type light emitting devices), and third color light emitting LEDs (i.e., third-type light emitting devices) employed in a prior art integrated back light unit employing three types of LEDs emitting light at different wavelengths to provide white light to a light guide unit of the integrated back light unit of the present disclosure.

The combination of the light from the plurality of blue-light-emitting light emitting devices that passes through the phosphor material and the phosphor converted light can provide white light that can be scattered by the light guide unit to provide white backlight with a fewer number of LEDs and with higher efficiency than white light obtained by combination of red, green, and blue lights.

Although the foregoing refers to particular preferred embodiments, it will be understood that the disclosure is not so limited. It will occur to those of ordinary skill in the art that various modifications may be made to the disclosed embodiments and that such modifications are intended to be within the scope of the disclosure. Where an embodiment employing a particular structure and/or configuration is illustrated in the present disclosure, it is understood that the present disclosure may be practiced with any other compatible structures and/or configurations that are functionally equivalent provided that such substitutions are not explicitly forbidden or otherwise known to be impossible to one of ordinary skill in the art.

What is claimed is:

1. An integrated back light unit, comprising:
a light emitting device assembly comprising at least one light emitting device located in a reflective mixing chamber containing reflective walls;
a light guide unit optically coupled to said at least one light emitting device to receive light from the at least one light emitting device; and
a phosphor material which is located remotely from the at least one light emitting device and configured to emit phosphor converted light upon irradiation from the at least one light emitting device.

2. The integrated back light unit of claim 1, wherein the at least one light emitting device comprises at least one light emitting diode (LED) which comprises at least one blue-light-emitting LED.

3. The integrated back light unit of claim 2, wherein a combination of the phosphor converted light from the phosphor material and blue light emitted from the at least one LED appears as white light to an observer.

4. The integrated back light unit of claim 2, further comprising an optically transparent encapsulant portion located in the reflective mixing chamber between the at least one LED and the phosphor material.

5. The integrated back light unit of claim 4, wherein the phosphor material is embedded in an adhesive material portion located between a light guide plate of the light guide unit and the encapsulant material portion.

6. The integrated back light unit of claim 5, wherein the adhesive material portion is bonded to a proximal sidewall surface of the light guide plate in the light guiding unit.

7. The integrated back light unit of claim 5, further comprising an optical launch including a material selected from silicone, polymer, and epoxy and is disposed between the optically transparent encapsulant portion and the adhesive material portion.

8. The integrated back light unit of claim 7, wherein the adhesive material portion is bonded to a distal sidewall surface of the optical launch.

9. The integrated back light unit of claim 2, wherein the phosphor material is embedded in a polycarbonate layer located between the light emitting device assembly and the light guide unit.

10. The integrated back light unit of claim 9, further comprising:
an optically transparent encapsulant portion located between the at least one LED and the phosphor material;
an optical launch including a material selected from silicone, polymer, and epoxy, and is disposed between the optically transparent encapsulant portion and polycarbonate layer, wherein the polycarbonate layer is disposed directly on the optical launch.

11. The integrated back light unit of claim 9, wherein:
the light guiding unit comprises a light guiding plate including a proximal sidewall that faces the light emitting device assembly; and
an air gap is located between the proximal sidewall of the light guiding plate and the polycarbonate layer.

12. The integrated back light unit of claim 2, wherein:
the light guiding unit comprises a light guiding plate including a proximal sidewall that faces the light emitting device assembly; and
the phosphor material is embedded in an end portion of the light guiding plate adjacent to the proximal sidewall of the light guiding plate.

13. The integrated back light unit of claim 12, further comprising:
an optically transparent encapsulant portion located between the at least one LED and the phosphor material; and
an optical launch including a material selected from silicone, polymer, and epoxy, and is disposed between the optically transparent encapsulant portion and the light guiding plate.

14. The integrated back light unit of claim 12, wherein an air gap is located between the proximal sidewall of the light guiding plate and the optical launch.

15. The integrated back light unit of claim 2, wherein the light emitting device assembly comprises an encapsulating matrix that is molded to encapsulate the at least one LED.

16. The integrated back light unit of claim 2, wherein the reflective walls of the reflective mixing chamber comprise a reflective material layer.

17. The integrated back light unit of claim 16, wherein:
the light guiding unit comprises a light guiding plate including a proximal sidewall that faces the light emitting device assembly; and
the reflective mixing chamber comprises an interstice in the reflective material layer containing an opening toward a side facing the light guide unit, and wherein the at least one LED is located in the interstice.

18. The integrated back light unit of claim 17, further comprising an optically transparent encapsulant portion located in the interstice between the at least one LED and the phosphor material.

19. The integrated back light unit of claim 18, wherein:
the phosphor material is embedded in a distal part of the optically transparent encapsulant portion that is located closer to the light guide unit than to the at least one LED;
a proximal part of the optically transparent encapsulant portion is located between the phosphor material and the at least one LED; and
the proximal part of the optically transparent encapsulant portion does not contain the phosphor material.

20. The integrated back light unit of claim 17, wherein:
the mixing chamber is configured to trap photons emitted by the at least one LED so that at least some of the photons take at least one bounce from the reflective walls of the mixing chamber before being absorbed by the phosphor material; and
the phosphor material is configured to emit upconverted photons in all directions such that the upconverted photons emitted backwards into the mixing chamber are then extracted forward from the mixing chamber.
